(19) United States
(12) Patent Application Publication
(10) Pub. No.: US 2026/0166918 A1
(43) Pub. Date: Jun. 18, 2026

(54) ADJUSTABLE POSITIONING DEVICE OF BEARING OF UNIVERSAL SIZES FOR SPINDLE OF HUB OF BICYCLE

(71) Applicant: CHUN-HUO LIN, Changhua County (TW)

(72) Inventor: CHUN-HUO LIN, Changhua County (TW)

(21) Appl. No.: 18/982,753

(22) Filed: Dec. 16, 2024

(51) Int. Cl. B60B 27/00; B60B 27/02; B60B 35/04; F16C 19/06; F16C 35/06

(52) U.S. Cl. CPC B60B 27/0078; B60B 27/023; B60B 35/04; F16C 19/06; F16C 35/06; B60B 2380/80; F16C 2326/01

(57) ABSTRACT

An adjustable positioning device of a bearing of universal sizes for a spindle of a hub of a bicycle contains: the hub, a spindle axially connected in the hub, two threaded portions formed on two ends of the spindle, and the two ends of the spindle being screwed with two bearings. Each bearing includes an external ring, an internal ring, and an operation portion formed around the internal ring. The internal ring of each bearing has a screw orifice defined thereon and configured to screw with the threaded portion of the spindle, such that the operation portion of each bearing is rotated along the threaded portion to adjustably move each bearing to a desired position. In addition, each bearing further includes a fixing nut connected on an end thereof to avoid a removal of each bearing.

### TECHNICAL FIELD

The present invention relates to spare parts of a hub of a bicycle, and more particularly to an adjustable positioning device of a bearing of universal sizes for a spindle of the hub of the bicycle.

### BACKGROUND

FIG. 1 is a cross sectional view of a conventional hub structure. However, the conventional hub structure has following defects:
1) To avoid the left and right offset after the hub 1 and the spindle 2 are assembled, which will affect the service life and the control accuracy of the deflection during a wheel travel, an tolerance range of a distance 111 between the bearing seats on two opposite sides of the hub 1 is extremely small, thus causing a high cost of the hub 1.
2) The spindle 2 must also meet the high precision requirements of the distance between two bearing seats of the hub 1 to prevent the spindle 2 from being offset from the hub 1 and causing the wheel to slip during operation. Therefore, it also causes the higher cost.
3) The spindle 2 needs to be precisely ground to match a diameter D of the internal hole of the bearing, thus having the high cost.
4) The spindle and the two bearing seats of the hub 1 are manufactured in different manufacturers, thus limiting use in different sizes and types. In other words, the spindle 2 and the hub 1 can be only matched in a same manufacturer, thus having troublesome maintenance and replacement.

As shown in FIG. 1, a diameter E of a shoulder is machined in the cost.

With reference to FIG. 2, another conventional hub has disadvantages as follows:
1) The ball bearing 6 has the adaptability to adjust the bearing seats on one pair of hubs for various types of hubs 1. However, because the ball bearing 6 is stamped by a punch, its operating efficiency and smoothness are far inferior to those of industrial ball bearing.
2) A retainer for corresponding to the ball bearing is hot-forging punched, so its operating efficiency and smoothness are far inferior to those of industrial ball bearing.
3) The ball bearing 6 is connected by a bowl, a cage, and the retainer 3, thus its dust and water resistance and service life are far inferior to those of industrial ball bearings of FIG. 1.

The present invention has arisen to mitigate and/or obviate the afore-described disadvantages.

### SUMMARY

The primary aspect of the present invention is to provide an adjustable positioning device of a bearing of universal sizes for a spindle of a hub of a bicycle which is capable of overcoming shortcoming of a conventional hub of a bicycle.

To obtain above-mentioned aspect, an adjustable positioning device of a bearing of universal sizes for a spindle of a hub of a bicycle provided by the present invention contains: the hub, a spindle axially connected in the hub, two threaded portions formed on two ends of the spindle, and the two ends of the spindle being screwed with two bearings. Each bearing includes an external ring, an internal ring, and an operation portion formed around the internal ring. The internal ring of each bearing has a screw orifice defined thereon and configured to screw with the threaded portion of the spindle, such that the operation portion of each bearing is rotated along the threaded portion to adjustably move each bearing to a desired position. In addition, each bearing further includes a fixing nut connected on an end thereof to avoid a removal of each bearing.

Preferably, a bowl cap is defined between the hub and each bearing, and the bowl cap includes a receiving groove defined on an inner wall thereof to accommodate each bearing.

Thereby, the adjustable positioning device of the present invention has advantages as follows:
1) A tolerance range of a distance between two bearing seats of the hub is enlarged to reduce a machining cost of the hub.
2) A pitch of the threaded portion of the spindle is adjustable by using the screw orifice of each bearing to freely correspond to the distance of the bearing seats of the hub, so the tolerance range of the tolerance range of the distance between the two bearing seats is enlarged to save the machining cost, and the shoulder of a back surface of each bearing is not machined to save a material cost and the machining cost.
3) The spindle is not ground to correspond to a diameter of an inner orifice of each bearing. In other words, the threaded portion of the spindle is machined to screw with internal threads of each bearing, so an inner wall of the spindle is not ground to reduce the machining cost of the spindle.
4) Sizes and types and of the spindle and the hub are not limited. In other words, the spindle and the hub are mated in universal sizes and types to reduce maintenance and replacement costs.
6) The adjustable positioning device of the second embodiment is applicable for universal ball bearings of the hub 1 and is connected easily.
7) Each bearing of the second embodiment is operated smoothly and has a long service life.
8) The bearing of the present invention is one-piece formed to enhance dust and water resistance and a service life.

### BRIEF DESCRIPTION OF THE DRAWINGS

FIG. 1 is a cross sectional view of a conventional hub structure

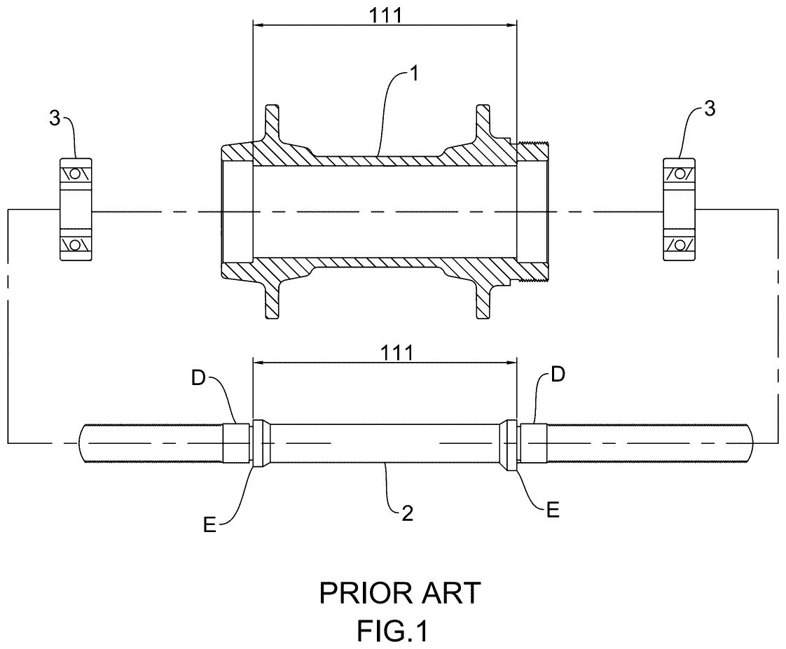

FIG. 2 is another cross sectional view of the conventional hub structure.

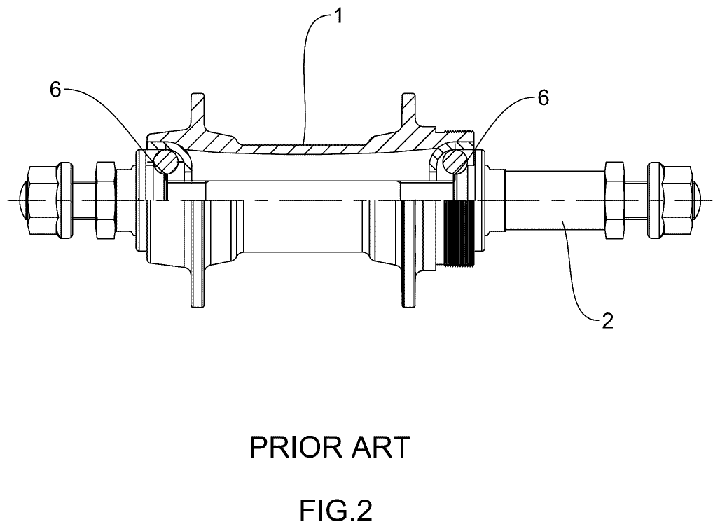

FIG. 3 is a cross sectional view showing the assembly of an adjustable positioning device of a bearing of universal sizes for a spindle of a hub of a bicycle according to a first embodiment of the present invention.

FIG. 4 is a cross sectional view showing the exploded components of the adjustable positioning device of the bearing of universal sizes for the spindle of the hub of the bicycle according to the first embodiment of the present invention.

FIG. 5 is a cross sectional view showing the assembly of an adjustable positioning device of a bearing of universal sizes for a spindle of a hub of a bicycle according to a second embodiment of the present invention.

FIG. 6 is a cross sectional view showing the exploded components of the adjustable positioning device of the bearing of universal sizes for the spindle of the hub of the bicycle according to the second embodiment of the present invention.

FIG. 7 is a perspective view showing the exploded components of the adjustable positioning device of the bearing of universal sizes for the spindle of the hub of the bicycle according to the present invention.

### DETAILED DESCRIPTION

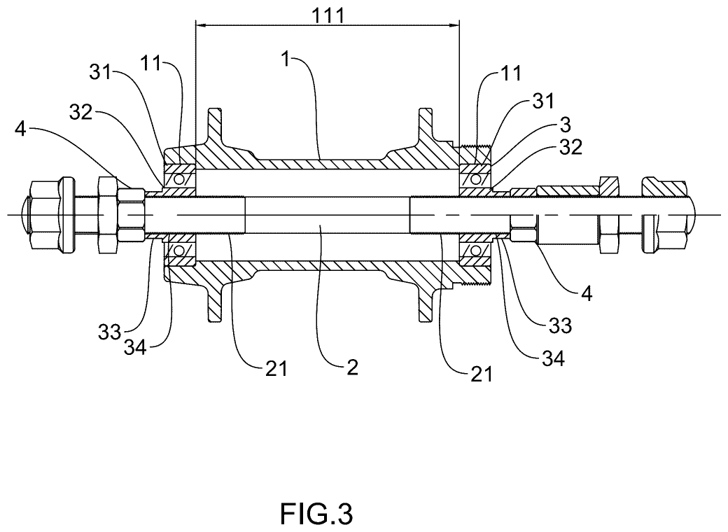

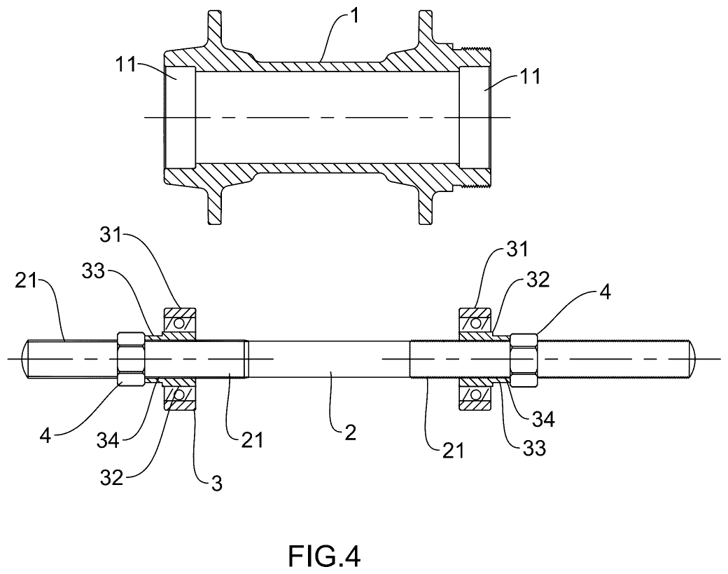

With reference to FIGS. 3 and 4, an adjustable positioning device of a bearing of universal sizes for a spindle of a hub of a bicycle according to a first embodiment of the present invention comprises: the hub 1, a spindle 2 axially connected in the hub 1, two threaded portions 21 formed on two ends of the spindle 2, and the two ends of the spindle 2 are screwed with two bearings 3, wherein each bearing 3 includes an external ring 31, an internal ring 32, and an operation portion 33 formed around the internal ring 32, wherein the internal ring 32 of each bearing 3 has a screw orifice 34 defined thereon and configured to screw with the threaded portion 21 of the spindle 2, such that the operation portion 33 of each bearing 3 is rotated along the threaded portion 21 to adjustably move each bearing 3 to a desired position, wherein each bearing 3 further includes a fixing nut 4 connected on an end thereof to avoid a removal.

Thereby, the adjustable positioning device of the first embodiment has advantages as follows:
1) A tolerance range of a distance 111 between two bearing seats 11 of the hub 1 is enlarged to reduce a machining cost of the hub 1.
2) A pitch of the threaded portion 21 of the spindle 2 is adjustable by using the screw orifice 34 of each bearing 3 to freely correspond to the distance 111 of the bearing seats 11 of the hub 1, so the tolerance range of the tolerance range of the distance 111 between the two bearing seats 11 is enlarged to save the machining cost, and the shoulder of a back surface of each bearing 3 is not machined to save a material cost and the machining cost.
3) The spindle 2 is not ground to correspond to a diameter of an inner orifice of each bearing 3. In other words, the threaded portion 21 of the spindle 2 is machined to screw with internal threads of each bearing 3, so an inner wall of the spindle 2 is not ground to reduce the machining cost of the spindle 2.

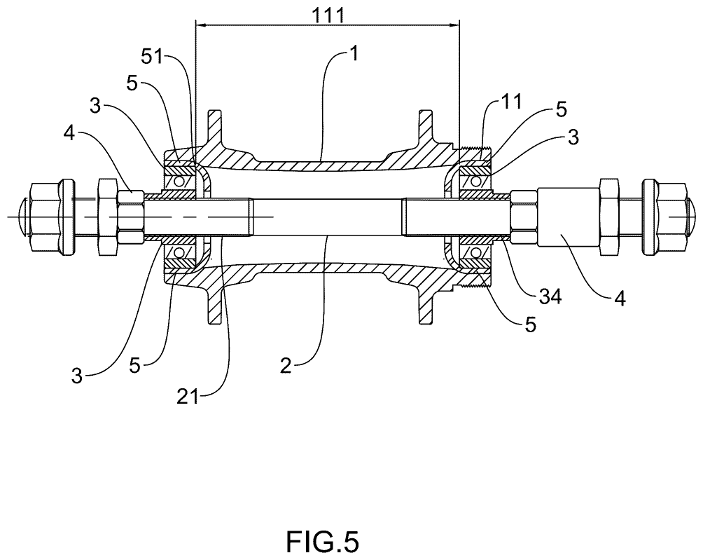

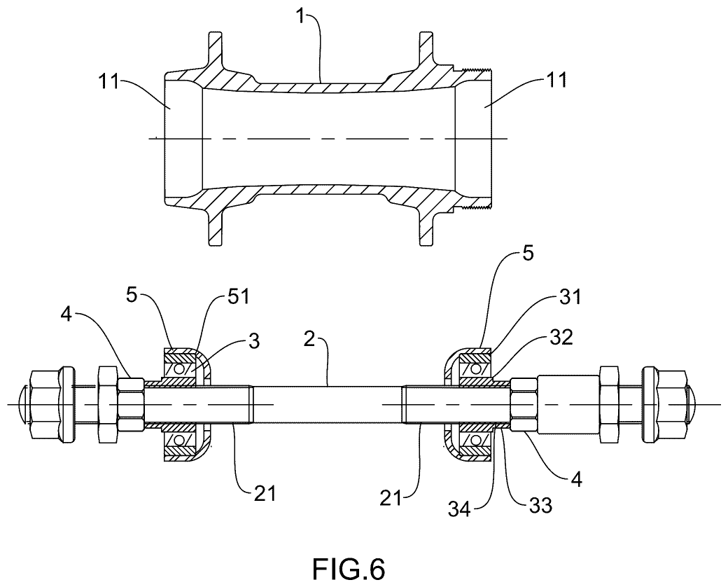

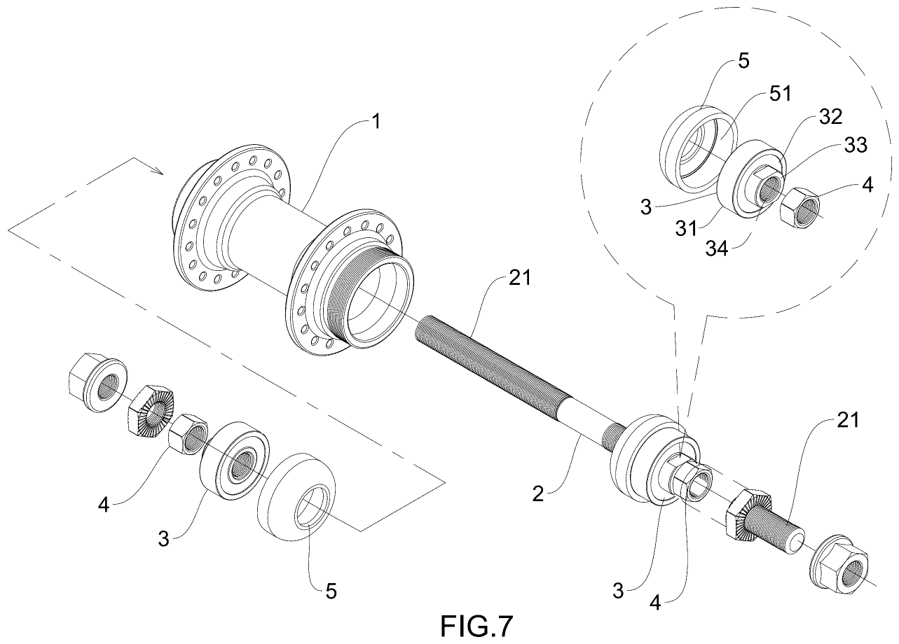

With reference to FIGS. 5-7, a difference of an adjustable positioning device of a second embodiment from that of the first embodiment comprises: a bowl cap 5 defined between the hub 1 and each bearing 3, and the bowl cap 5 includes a receiving groove 51 defined on an inner wall thereof to accommodate each bearing 3.

Thereby, the adjustable positioning device of the second embodiment has advantages as follows:
1) Sizes and types and of the spindle 2 and the hub 1 are not limited. In other words, the spindle 2 and the hub 1 are mated in universal sizes and types to reduce maintenance and replacement costs.
2) The adjustable positioning device of the second embodiment is applicable for universal ball bearings of the hub 1 and is connected easily.
3) Each bearing 3 of the second embodiment is operated smoothly and has a long service life.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. An adjustable positioning device of a bearing of universal sizes for a spindle of a hub of a bicycle comprising:
the hub, a spindle axially connected in the hub, two threaded portions formed on two ends of the spindle, and the two ends of the spindle being screwed with two bearings;
wherein each bearing includes an external ring, an internal ring, and an operation portion formed around the internal ring, wherein the internal ring of each bearing has a screw orifice defined thereon and configured to screw with the threaded portion of the spindle, such that the operation portion of each bearing is rotated along the threaded portion to adjustably move each bearing to a desired position, wherein each bearing further includes a fixing nut connected on an end thereof to avoid a removal of each bearing.

2. The adjustable positioning device as claimed in claim 1, wherein a bowl cap defined between the hub and each bearing, and the bowl cap includes a receiving groove defined on an inner wall thereof to accommodate each bearing.
